(19) United States
(12) Patent Application Publication
(10) Pub. No.: US 2007/0012712 A1
(43) Pub. Date: Jan. 18, 2007

(54) Automated medication dispenser

(76) Inventor: Tin-Jon Syiau, San Gabriel, CA (US)

Correspondence Address: Raymond Y. Chan, #128, 108 N. Ynez Ave., Monterey Park, CA, 91754, US

(21) Appl. No.: 11/181,227

(22) Filed: Jul. 13, 2005

(51) Int. Cl. G07F 11/00

(52) U.S. Cl. 221/2

(57) ABSTRACT

A medication dispenser includes a docking station including a medication container having a plurality of medication compartments for storing medications in a securely organized manner, and an accessing door adapted to align with one of the medication compartments for the corresponding medications withdrawing therefrom. A time delivering controller includes a control panel for presetting a predetermined time interval as a medication administration time corresponding to a time instruction of the medications, and a time reminder communicatively linked to the control panel for generating a delivery reminding signal at the medication administration time. A medication delivery controller includes a power source actuates the docking station at a position that the accessing door is aligned with the corresponding medication compartment at the medication administration time, such that the accessing door is allowed to be opened for exactly dispensing the medication in the respective medication compartment in timely organizing manner.

### BACKGROUND OF THE PRESENT INVENTION

1. Field of Invention

The present invention relates to a medical apparatus, and more particularly to a an oral medication dispenser, which provides a programmed instruction corresponding to the present time reminding patients to promptly take the medication in a simplified and organized manner. If the medication is taken or not taken the feedback mechanism makes an on going log to classify and catalog compliance of the patient.

2. Description of Related Arts

Arguably patient compliance is paramount in the effectiveness of therapeutic regimens. Without compliance therapeutic goals cannot be achieved resulting in poorer patient outcomes.

It is well known to the medical community that compliance is difficult to achieve. Many drug companies have tried different ways to achieve better compliance such as trans-dermal patches that can be placed on a patient's skin for 72 hours to a week, or injections that can be given weekly or monthly. However, more than 95% of medications as listed in PDR are still in oral pill forms. This includes most medications that need to be administered chronically, such as antihypertensive or anti-diabetic medications, for which compliance is most difficult to achieve.

Studies have shown that there are numerous motivations for people not to take their prescribed medication. For example, some medicines do not taste well; some medicines are hard to swallow; there are too many types of medicine; people do not have the time; people tend to forget. As people in general develop psychological rejections to taking their medicine ill-willingly against their physicians' orders the apparent problem becomes a major attribute to poor medical compliance and poor drug effectiveness.

Given, people develop good/bad habits that develop into routines. Bad routines yield bad health and hygiene.

Furthermore, numerous studies indicate that compliance is imperative to any medical treatments, yet little was done to improve it. For any given medication to effectively accomplish its purpose or convey ineffectiveness the patient must unconditionally follow the guideline given by his or her physician, medical technician and the pharmacist within the proper timeframe and the proper interval per consumption. Also for such a procedure to properly function there must be a running tally that is communicated to the physician and his or her staff to help assist in a proper routine. Also as an additional benefit the same tally can be monitored by the Government via the Food and Drug Administration (FDA) and in brief by pharmaceutical companies for large-wide-scale sample statistical analysis, i.e. effectiveness/ineffectiveness.

Often medication organization can become over burdening or a complete drudgery when a patient has to take two or more types of medicine over a certain period of time. Also the names of medication can become overwhelming with the long names, multiple syllables, derived Latin wording etc. Unless trained in the art of filling pharmacy, identifying and recognizing medicine by size, smell, color, shape and feel will be near impossible. For the elderly and those suffering for acute arthritis, it has become apparent that “child-proof” containers are becoming “senior-proof” and “arthritis-proof” in terms of the ease of operating a medicine bottle. This list goes on and on. These negative stimuli impede good medical compliance. Apparently “take two of these and call me in the morning” does not exist in this day in age or will for quite some time.

“People forget.” With other stimulus in daily routines such as waking up in the morning, brushing teeth, making bed, go to “work”, doing what has to be done at “work”, etc. The most people do not carry palm computers with reminders nor do not necessarily place taking prescription medication on top of their daily routine.

Patient often have poor knowledge of their prescribed drug regimen and so do not comply fully with it. Physicians, medical technicians, and pharmacists do not take proper time to elaborate the importance of taking the medicine the physician prescribed. Often times, patients believe that their body can heal or develop resistance to disease by not following the physicians' orders. Yet physicians or their staffs do not all take time to follow-up with the patients in taking medicine. When the patients return and the regimen does not seem to be working, the physician will either increase the dosage or change prescription. The physician unfortunately does not know if his or her patient follows the prescription regimen. Government Medicare and private health care systems are losing millions of dollars a year on wasted unconsumed prescription. Often time's patients will get refills of medication when the doctor writes another prescription form and a health care ID is shown at the local pharmacy. As medication are not properly consumed, healthcare cost increase treatments are seemingly ineffective or inadequate. As the population in general increases and the senior population triples in the next seven years more expense will be wasted on unconsumed medicines. When patients do not sustain good medical compliance medicines are thrown away into trash receptacles costing the government Medicare and private health care systems millions of dollars a year and the numbers will increase exponentially. Also the government Medicare and private health care systems blindly do not know the statistics of medical compliance for the recipient they support. With such data, the government Medicare and private health care systems can regulate and fine tune expenditure of prescription usage efficiently.

There are several solutions that pharmaceutical companies have attempted to provide solutions to promote compliance of medication. Most new medications are produced to decrease the frequency of administration. For example, older generation oral antibiotics, antihypertensive medications, as well as anti-diabetic medications were taken four times a day (such as tetracycline, amoxicillin, captopril, etc.). Newer generation medications are produced so they can be taken only once a day (such as azithromycin, levaquin, lotensin, etc.). However, decrease in frequency for taking these medications also means significant increase in the cost of these medications. For instance, a 5-day-course of azithromycin costs 3 times more than a 7-day-course of amoxicillin. Many medications are made in form of XL (extended release), and again cost a lot more, and often not covered by insurance.

A second solution is to decrease number of medications needed to be taken. Decrease number of medications that needs to be taken by combining different medications. For instance, “Lotrel” is a combination of amlodipine and benazepril.

A third solution is to change ways of application. Catapress Patch TTS, clonidine patch that sticks to the chest applied once weekly. Other significantly examples are Nicotine patch or nasal spray.

A fourth solution is to improve the taste of medication, mostly used for pediatric medications, for easy administration.

A fifth solution is to increase the cost of the medications to enforce the patient to take the medication. Generally speaking, most up-to-date generation medications are much more expansive than the older generation medications.

A sixth solution is to decrease the side effects of different classes of medications so as to enhance and encourage the patient to take the medications. Most notably are the antihypertensive medications.

A seven solution is to improve the organization of medication. There are some prototype medication dispensers that organize the medication at weekly intervals. However, such medication dispensers are generally bulky and are very confusing for filling up the medications.

However, the above solutions cannot guarantee for the patients to promptly take the medication in a simplified and organized manner.

### SUMMARY OF THE PRESENT INVENTION

A main object of the present invention is to provide a medication dispenser which embodies as a medication delivery device to provide a reminders and simple medication administration procedure-instruction in respect to time for the patients to promptly take the medication in a simplified and organized manner.

Another object of the present invention is to provide a medication dispenser, wherein a time reminder generates a reminding signal in a predetermined time interval to remind the patient to take the medication pre-stored in the medication dispenser such that the patient is able to promptly take the medication without delaying the instruction time of medication.

Another object of the present invention is to provide a medication dispenser, wherein the medications are pre-sorted out to fill in the medication compartments in an organized manner such that the patient is able to take the medications in each medication compartment without confusion.

Another object of the present invention is to provide a medication dispenser, wherein an accessing door is timely unlocked for allowing the patient to withdraw the medication in a particular medication compartment for preventing the patient from mistaking the medications in the medication dispenser.

Another object of the present invention is to provide a medication dispenser, wherein the medications are filled and organized in the medication dispenser by licensed registered pharmacist such that the patient simply follows the instruction of the medication dispenser to take the medications in a time reminding manner. In addition, the prescription is directly sent to the pharmacist and is recorded so as to keep all the prescription record for further tracking purpose. The data logging will be microprocessor dependent.

Another object of the present invention is to provide a medication dispenser, wherein a log of each time when the patient accessing of the medication compartment is recorded such that the physician is able to verify whether the medications are taken timely or not so as to promote compliance of medication and to prevent the waste of the medication. In other words, the recorded data indicates the frequency of administration from the patient.

Another object of the present invention is to provide a medication dispenser, which can increase patient oral medical compliance, establish a patient-recipient database and decrease government expenditures on unused-unconsumed prescription medicines, so as to provide an efficient solution focusing on medication organization, delivery, reminder, compliance report, and secure patient database.

Accordingly, in order to accomplish the above objects, the present invention provides a medication dispenser, comprising:

a docking station comprising a medication container having a plurality of medication compartments for storing medications in a securely organized manner, and an accessing door which is coupled with the medication container and is adapted to align with one of the medication compartments for the corresponding medications withdrawing therefrom;

a time delivering controller which comprises a control panel supported by the docking station for presetting a predetermined time interval as a medication administration time corresponding to a time instruction of the medications, and a time reminder communicatively linked to the control panel for generating a delivery reminding signal at the medication administration time; and

a medication delivery controller comprising a power source which is electrically activated by the time delivering controller to actuate the docking station at a position that the accessing door is aligned with the corresponding medication compartment at the medication administration time, such that the accessing door is allowed to be opened for exactly dispensing the medication in the respective medication compartment in timely organizing manner.

The present invention further provides a method of timely dispensing medications by a medication dispenser, comprising the steps of:

(a) pre-storing the medications in a plurality of medication compartments of the medication dispenser in an organized manner, wherein the medications in the medication compartments are normally unable to be withdrawn;

(b) presetting a predetermined time interval as a medication administration time corresponding to a time instruction of the medications;

(c) generating a delivery reminding signal at the medication administration time; and

(d) allowing one of the medication compartments to be accessed at the medication administration time for exactly dispensing the medication in the respective medication compartment in timely organizing manner.

The present invention further comprises a method of promoting compliance of medication by a medication dispenser, comprising the steps of:

(A) communicatively networking physicians with pharmacist to form a medical network;

(B) recording a prescription as a medical record when the prescription is transmitted through the medical network, wherein the prescription contains a list of the medications for a particular patient and a time instruction of the medications;

(C) preparing the medications in a plurality of medication compartments of the medication dispenser in an organized manner, wherein each of the medication compartments is allowed to be accessed at a medication administration time corresponding to the time instruction of the medications for exactly dispensing the medication in the respective medication compartment in timely organizing manner according to the prescription; and

(D) keep tracking a log of the medication dispenser at every time of each of the medication compartments being accessed for the medication to be delivered, so as to adjust an expenditure of prescription usage efficiently.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a medication dispenser according to a preferred embodiment of the present invention.

FIG. 2 is a schematic view of the medication dispenser according to the above preferred embodiment of the present invention.

FIG. 3 is a schematically sectional view of the medication dispenser according to the above preferred embodiment of the present invention.

FIG. 4 is a block diagram of the medication dispenser according to the above preferred embodiment of the present invention.

FIG. 5 is a flow diagram of a method of timely dispensing medications by the medication dispenser according to the above preferred embodiment of the present invention.

FIG. 6 is a flow diagram of a method of promoting compliance of medication by the medication dispenser according to the above preferred embodiment of the present invention.

FIG. 7 is a block diagram of the method of promoting compliance of medication by the medication dispenser according to the above preferred embodiment of the present invention.

FIG. 8 illustrates the scheme of promoting compliance of medication by the medication dispenser according to the above preferred embodiment of the present invention.

FIGS. 9A and 9B illustrate the filling funnel of the medication dispenser according to the above preferred embodiment of the present invention.

### DETAILED DESCRIPTION OF THE PREFERRED EMBODIMENT

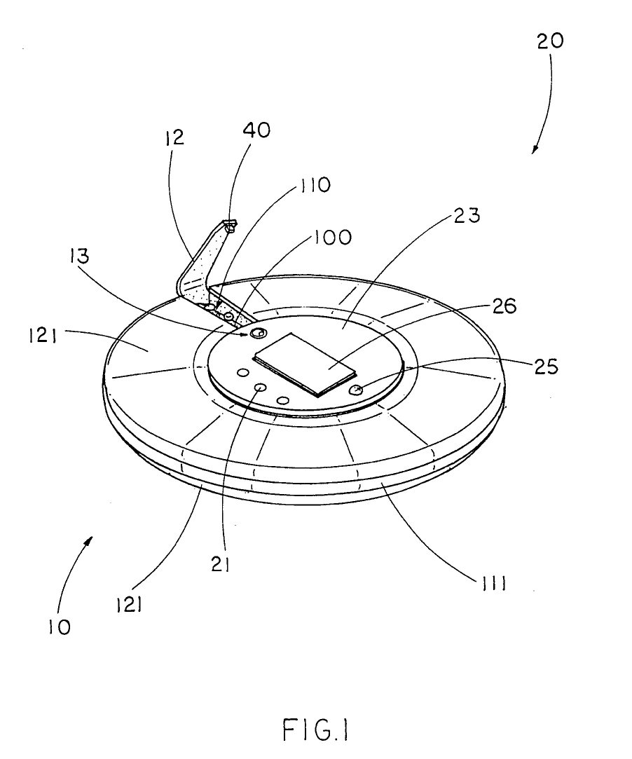

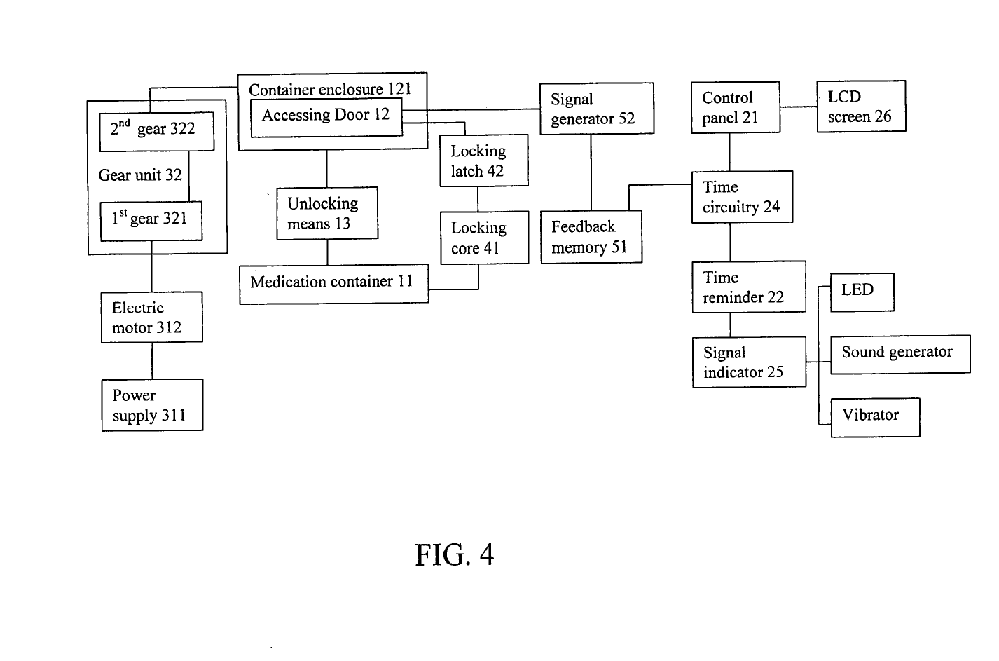

Referring to FIGS. 1 to 4 of the drawings, a medication dispenser, which is embodied as a medication delivery device to provide a time reminding instruction for the patients to promptly take the medication in a simplified and organized manner, according to a preferred embodiment of the present invention is illustrated, wherein the medication dispenser, which is configured as a REgulated Medication INterval Dispenser Compact (REMIND), comprises a docking station 10, a time delivering controller 20, and a medication delivery controller 30.

The docking station 10 comprises a medication container 11 having a plurality of medication compartments 110 for storing medications in a securely organized manner, and an accessing door 12 which is coupled with the medication container 11 and is adapted to align with one of the medication compartments 110 for the corresponding medications withdrawing therefrom. Accordingly, the medications are preferably oral medications to be stored in the docking station 10. However, other types of medications, such as solution types or injection types, can also be stored in the docking station 10 by additional bottles.

The time delivering controller 20 comprises a control panel 21 supported by the docking station 10 for presetting a predetermined time interval as a medication administration time corresponding to a time instruction of the medications, and a time reminder 22 communicatively linked to the control panel 21 for generating a delivery reminding signal at the medication administration time.

The medication delivery controller 30 comprises a power source 31 which is electrically activated by the time delivering controller 20 to actuate the docking station 10 at a position that the accessing door 12 is aligned with the corresponding medication compartment 110 at the medication administration time, such that the accessing door 12 is allowed to be opened for exactly dispensing the medication in the respective medication compartment 110 in timely organizing manner.

According to the preferred embodiment, the docking station 10, which is a handy and compact medication carrier, is preferably in a shape of a circular disk approximately 16 cm in diameter and less than 3 cm in depth.

The medication container 11 comprises a disk body 111 defining an inner circular rim 112 and an outer circular rim 113, wherein the medication compartments 110 are formed between the inner and outer circular rims 112, 113 in a radial direction for storing the medications.

The docking station 10 further comprises a container enclosure 121 detachably covering on the disk body 111 to enclose the medication compartments 110, wherein the accessing door 12 is provided on the container enclosure 121 such that when the container enclosure 121 is rotatably turned with respect to the disk body 111, the accessing door 12 is driven to align with one of the medication compartments 110. In other words, once the accessing door 12 is allowed to be opened for exposing the respective medication compartment 110, the medications therein is adapted to be withdrawn. In other words, the docking station 10 is normally sealed for preventing the medications from being withdrawn.

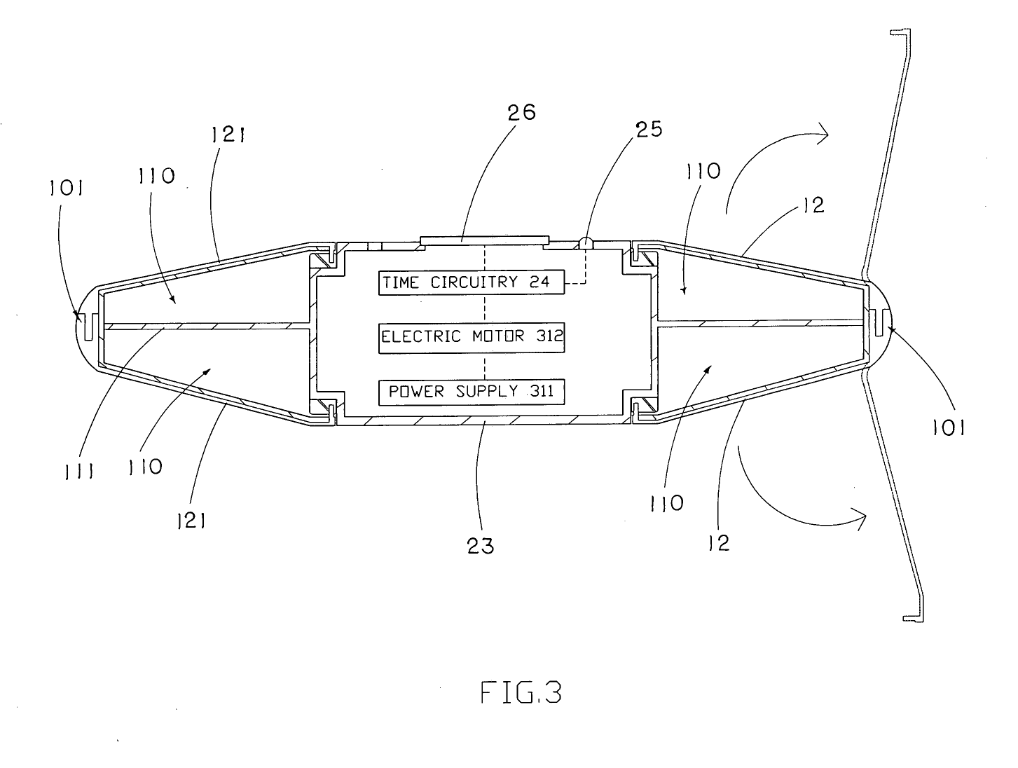

As shown in FIG. 3, the container enclosure 121 is sealedly mounted to the disk body 111 by the tongue-groove structure 101 to seal the edges between the container enclosure 121 and the disk body 111 so as to prevent air and moisture entering into the medication compartments 110. Accordingly, a groove and a tongue are respectively formed along outer circular edges of the disk body 111 and the container enclosure 121 such that the tongue is fittingly inserted into the groove to seal the outer circular edges of the disk body 111 and the container enclosure 121 so as to seal the medication compartments 110 therebetween.

According to the preferred embodiment, the docking station 10 further comprises means 13 for unlocking the container enclosure 121 with the medication container 11 in an authorized manner. Accordingly, the container enclosure 121 is normally and securely locked up with the medication container 11 such that the patient is allowed to withdraw the medication only when the accessing door 12 is opened at the medication administration time. However, only the authorized people, such as physicians and/or pharmacists, are able to access the unlocking means 13 to detach the container enclosure 121 from the medication container 11 for refilling the medications or other particular purpose. It is worth to mention that the unlocking means 13 can be a password input at the control panel 21 or an official key to unlock an actuator lock which securely locks up the container enclosure 121 with the medication container 11.

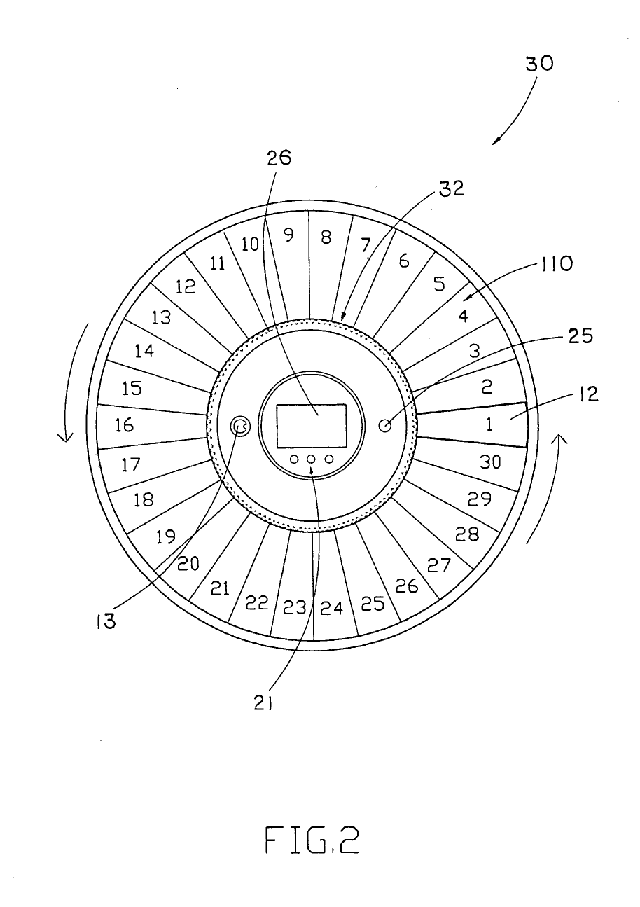

As shown in FIG. 2, the docking station 10 further comprises a plurality of sterilizing layers 100 provided on the medication compartments 110 respectively to keep the medication compartments 110 sterile and clean for storing the medications. Each of the sterilizing layers 100 has excellent chemical resistance and thermal insulation. Therefore, when the medications are stored in the medication compartments 110, the medications are kept in a good condition by the sterilizing layers 100. In addition, the medication compartments 110 can be easily cleaned with the sterilizing layers 100 coated thereon so as to allow the medication container 11 to be reused for refilling the medications. Accordingly, each of the sterilizing layers 100 is preferably made of “Teflon” which is a copolymer of ethylene and tetrafluoroethylene.

As shown in FIG. 1, the docking station 10 is embodied as a double-sided carrier that the medication container 11 defines a plurality of upper medication compartments 110 and a plurality of lower medication compartments 110 for increasing numbers of medications to be stored in the docking station 10, wherein there are two container enclosures 121 to enclose the upper and lower medication compartments 110. In addition, the two accessing doors 12 are respectively formed on the two container enclosures 121. Therefore, by controlling the access of the accessing doors 12, i.e. allowing only one of the accessing doors 12 to be opened at the medication administration time or allowing both accessing doors 12 to be opened at the medication administration time, the medications can be timely dispensed by the medication dispenser.

Alternatively, a plurality of accessing doors 12 are provided on the container enclosure 121 to align with the medication compartments 111 respectively, wherein one of the accessing doors 12 is allowed to be accessed at the medication administration time for withdrawing the medication in the respective medication compartment 110. Therefore, for next medication administration time, another accessing door 12 is allowed to be accessed for next medication administration.

The time delivering controller 20, which is embodied as a time counter for time counting, further comprises a housing 23 provided at the docking station 10 and a time circuitry 24 which is received in the housing 23 and is electrically connected to the control panel 21. Accordingly, the control panel 21 is adapted for allowing an authorized person, such as the physicians or pharmacist, to preset the medication administration time to be stored in the time circuitry 24 such that the time reminder 22 is automatically triggered by the time circuitry 24 to generate the delivery reminding signal at the medication administration time. It is worth to mention that the daylight savings adjustment calendar is preset in the time circuitry 24 in order to provide an accurate time counting for the medication administration time.

Accordingly, the medication administration time can be adjustably preset in different time intervals. For example, the medication administration time is set as 4 hours for the medication A stored in the medication compartment A and is set as 6 hours for the medication B stored in the medication compartment B. The accessing door 12 is automatically switched to align at the medication compartment A at the 4-hour medication administration time for allowing the medication A to be withdrawn while the accessing door 12 is then switched to align at the medication compartment B at the 6-hour medication administration time for allowing the medication B to be withdrawn.

The time delivering controller 20 further comprises a signal indicator 25 electrically connected to the time reminder 22 to indicate the delivery reminding signal. Accordingly, the signal indicator 25 comprises at least a LED supported on the housing 23 for generating a light effect as the delivery reminding signal when the time reminder 22 is triggered. Alternatively, the signal indicator 24 comprises a sound generator supported on the housing 23 for generating an alerting sound as the delivery reminding signal when the time reminder 22 is triggered. In addition, the signal indicator 24 can be a vibrator supported by the housing 23 for generating a vibrating force to the docking station 10 as the delivery reminding signal the delivery reminding signal when the time reminder 22 is triggered. In other words, the signal indicator 25 is used as an alert device to get the patient attention so as to remind the patient to take the medication timely.

The time delivering controller 20 further comprises a LCD screen 26 provided on the housing 23 and electrically linked to the control panel 21 for displaying medication info such as a simple countdown timer and clock for the next batch of medication would be taken.

The power source 31 comprises a power supply 311 supported in the housing 23 and an electric motor 312 electrically connected to the power supply 312 to drive the docking station 10 at a position that the accessing door 12 is aligned with the corresponding medication compartment 110 at the medication administration time. Accordingly, the power supply 311 can be a rechargeable battery or a replaceable battery disposed in the housing 23 for supplying electrical power to the electric motor 312.

According to the preferred embodiment, the medication delivery controller 30 further comprises a gear unit 32 engaging the electric motor 312 with the container enclosure 121 wherein the gear unit 32 comprises a first gear 321 coupling with the electric motor 312 and a second gear 322 coupling at the container enclosure 121 to engage with the first gear 321 such that when the electric motor 312 is actuated at the medication administration time to drive the first gear 321 to rotate, the second gear 322 is driven by the first gear 321 to rotate so as to turn the container enclosure 121 until the accessing door 12 is aligned with the corresponding medication compartment 110. In other words, the container enclosure 121 is driven to turn by the electric motor 312 to align the accessing door 12 with the corresponding medication compartment 110. Accordingly, the container enclosure 121 is angularly turned to precisely align the accessing door 12 with the respective medication compartment 110. For example, when the medication container 11 has thirty medication compartments 111, the container enclosure 121 will turn 12° at each medication administration time to align the accessing door 12 with the respective medication compartment 110. It is obvious that the medication container 11 can be driven to turn by the electric motor 312 to align the corresponding medication compartment 110 with the accessing door 12.

The medication dispenser further comprises means 40 for releasably locking the accessing door 12 with the medication container 11, wherein the locking means 40 comprises a locking core 41 provided at the medication container 11 and a locking latch 42 actuated by the locking core 41 between a locking position and a releasing position. In which, at the locking position, the locking latch 42 is engaged with the accessing door 12 to lock up the accessing door 12 for preventing the accessing of the medication compartments 110 and at the releasing position, the locking latch 42 is disengaged with the accessing door 12 to automatically release the accessing door 12 at the medication administration time for allowing the respective medication compartment 110 to be accessed. It is worth to mention that the locking latch 42 is controlled by the time delivering controller 20 to release the engagement between the accessing door 12 and the medication container 11 at the medication administration time such that accessing door 12 can only be accessed when the locking latch 42 is released at the medication administration time.

The medication dispenser further comprises a medical recorder 50 electrically linked to the time delivering controller 20 for generating a medication log when the accessing door 12 is accessed. The medical recorder 50 comprises a feedback memory 51 electrically coupled with the time circuitry 24 of the time delivering controller 20 and a signal generator 52 arranged in such a manner that when the accessing door 12 is opened for withdrawing the medication within the corresponding medication compartment 110, the signal generator 52 generates a feedback signal as the medication log to be stored in the feedback memory 51 so as to keep track a frequency of administration timely.

Accordingly, the physicians and/or pharmacists are able to ensure the patient whether he or she take the medications timely by obtaining the medication log in the medical recorder 50. A computerizing outlet, such as USB port, is provided on the docking station 10 to communicatively link to the medical recorder 50 such that the physicians and/or pharmacists are able to communicatively connect the medication dispenser to their computer system via the computerizing outlet so as to obtain the medication log from the medication dispenser of the present invention. In other words, the physicians and/or pharmacists are able to verify whether the medications are taken timely or not to promote compliance of medication and to prevent the waste of the medication.

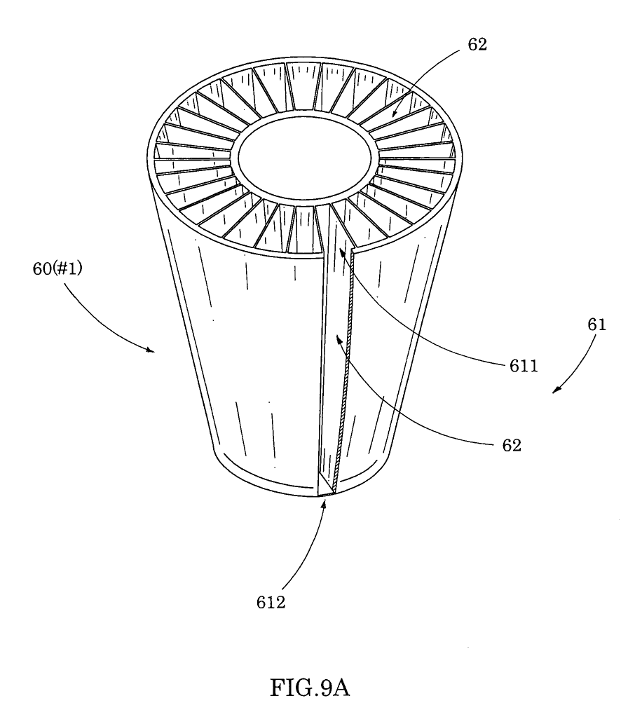

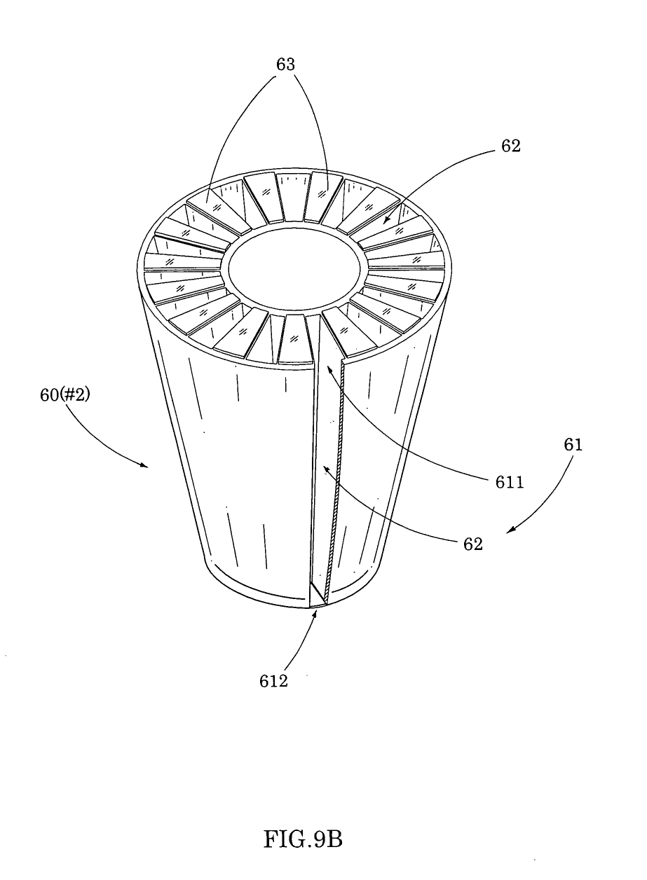

As shown in FIG. 9A, the medication dispenser of the present invention further comprises a filling funnel 60 for filling the medications in the medication compartments 110 of the docking station 10. The filling funnel 60 comprises a funnel body 61 having a filling inlet 611 and a filling outlet 612 and a plurality of filling channels 62 extended from the filling inlet 611 to the filling outlet 612 to align with the medication compartments 110 respectively. The filling inlet 611 has a size larger than a size of the filling outlet 612 such that the physician is able to easily fill the medications into the medication compartments 110.

Accordingly, for fully filling up the medication dispenser, the number of the filling channels 62 is corresponding to the number of the medication compartments 110 such that when the filling funnel 60 (#1) is placed on the docking station 10 to communicate the filling outlet 612 with the medication compartments 110, the physician is able to fill the medications at the filling inlet 611 into the medication compartments 110 through the filling channels 62. As shown in FIG. 9B, a plurality of funnel lips 63 cover at the filling inlet 611 to enclose some of the filling channels 62 for filling the medications into the medication compartments 110 without the funnel lips 63 covering on the filling funnel 60 (#2). In other words, the physician is able to selectively fill the medications into the medication compartments 110 by using the filling funnel 60 (#1 or #2) with or without the funnel lips 63.

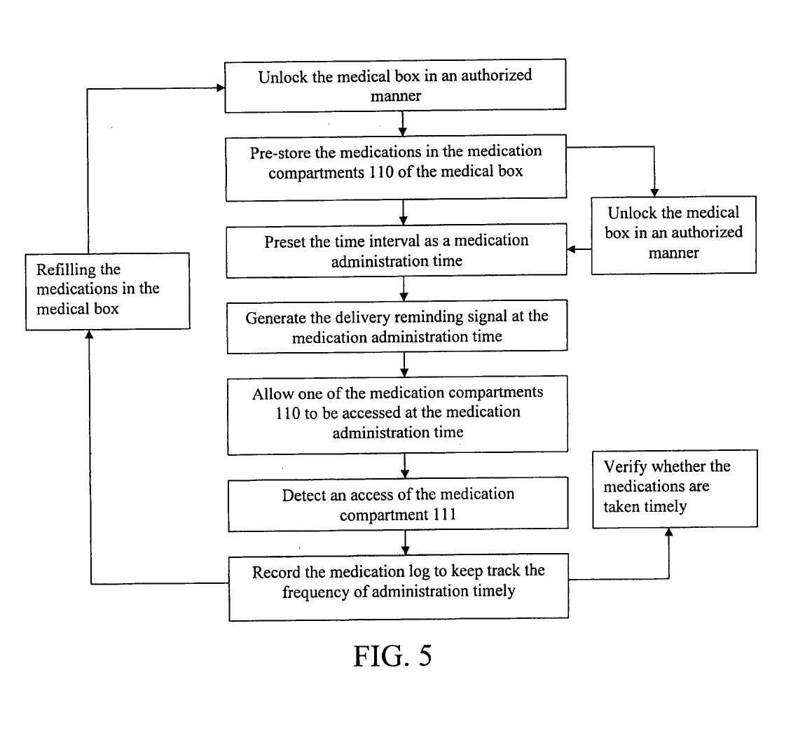

According to the preferred embodiment, a method of timely dispensing medications by the medication dispenser, as shown in FIG. 5, comprises the following steps.

(1) Pre-store the medications in the medication compartments 110 of the medication dispenser in an organized manner, wherein the medications in the medication compartments 110 are normally unable to be withdrawn. Before the step (1), the method of the present invention further comprises a step of unlocking the medication dispenser in an authorized manner, wherein the medication dispenser is normally sealed for preventing the medication from being withdrawn such that the medication dispenser only allows to be opened by an authorized person, such as a physician or a pharmacist, to prepare the medications. It is worth to mention that after the medications are prepared in the medication dispenser, the medication dispenser must be re-locked by the authorized person to prevent the medications therein from be accessed improperly regarding to the instruction of the medication dispenser.

(2) Preset the time interval as a medication administration time corresponding to the time instruction of the medications through the control panel 21. Preferably, only the authorized person, such as a physician or a pharmacist, is allowed to preset the time interval.

(3) Generate the delivery reminding signal at the medication administration time by the time reminder 22.

(4) Allow one of the medication compartments 110 to be accessed at the medication administration time for exactly dispensing the medication in the respective medication compartment 110 in timely organizing manner. Accordingly, the accessing door 12 is driven to turn at a position aligning with the respective medication compartment 110 for allowing the medication therein to be withdrawn.

The method of timely dispensing medications of the present invention further comprises the following steps.

(5) Detect an access of the medication compartment 110 when the accessing door 12 is opened to generate the medication log by the signal generator 52.

(6) Record the medication log in the feedback memory 51 to keep track the frequency of administration timely. Therefore, the physician is able to verify whether the medications are taken timely or not so as to promote compliance of medication and to prevent the waste of the medication.

It is worth to mention that when all the medications in the medication dispenser are withdrawn, the patient is able to bring the medication dispenser back to the physician or the pharmacist for refilling the medications in the medication dispenser as in step (1) while the physician or the pharmacist will reset the medication administration time as in step (2).

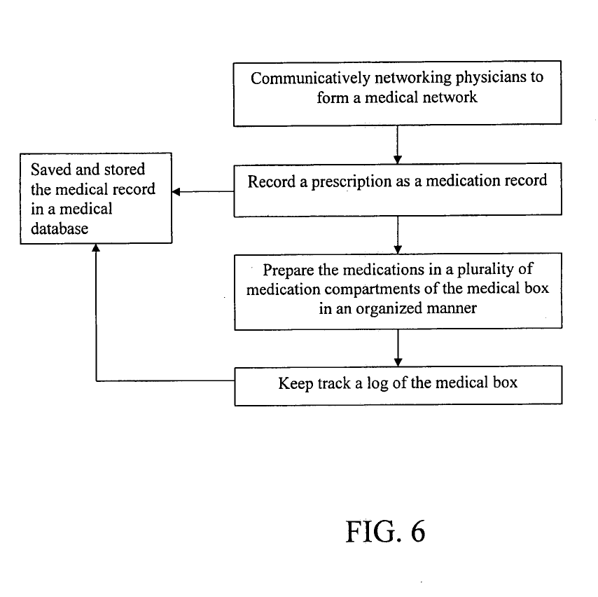

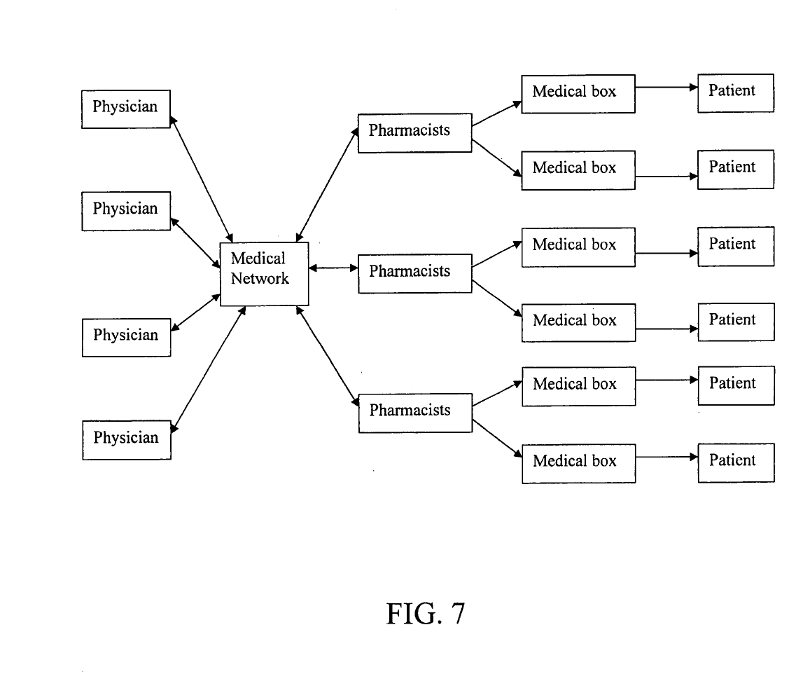

As shown in FIGS. 6 to 8, the present invention further comprises a method of promoting compliance of medication by a medication dispenser, comprising the steps of:

(A) Communicatively networking physicians to form a medical network. Accordingly, the pharmacists are also networked in the medical network since they are able to organize the medications in the medication dispenser. However, in some countries, private clinics having licensed or registered technicians for delivering the medications to the patient should be included in the medical network. Accordingly, the physicians and/or the pharmacists are networked through a communication network such as Internet to form the medical network.

(B) Record a prescription as a medical record when the prescription is transmitted through the medical network, wherein the prescription contains a list of the medications for a particular patient and a time instruction of the medications. All medical records sending from the physicians to the pharmacists are saved and stored in a medical database when the prescription is transmitted through the medical network. In other words, the medical records are saved and stored in the medical database that the physicians with authorization are allowed to access the medical database through said medical network. By saving all the records, the physician can refill, rewrite or adjust prescription medication through the medical network. In addition, prescription written by different physicians will be automatically recognized such that the pharmacists are able to understand clearly for preparing the medications in the medication dispenser.

Accordingly, the doctor will determine the compliance rate and adjust the medication. Rate of noncompliance would be calculated and recorded in the digit data base in the medication dispenser of the present invention.

The medical database is linked to a computerized system to analyze the medical records. If known reactions between different medications, the computerized system will automatically notify the patient's physician of the possible reaction via the constantly updating database. Accordingly, the prescription will automatically be archived, calculated, and sorted in the medical database such that the pharmacist should simply follow the instruction and fill the quadrants with the appropriate medication.

The medical database is utilized a 128-bit encryption protocol with multiple back-up points (RAID) with firewall protection. The medical database is incorporated with the computerized system and information will be securely by uploaded into the computerized system as soon as the physician and pharmacist docks the computerized system and closes operation. The medical database will be sorted by the patients medical history folder including general health notes, social security number for identification (privacy statements will be provided), nearest family to call in case of emergency, etc. Accordingly, only authorized people, such as physicians and pharmacists, are able to access the medical database through the medical network.

It is worth to mention that the pharmacist will check the prescription for side effects, drug interaction or allergic reaction wherein the pharmacist will link the medication dispenser to the computer such that the computer will read out the compliance and record it to determine the medication filling.

(C) Prepare the medications in a plurality of medication compartments of the medication dispenser in an organized manner, wherein each of the medication compartments is allowed to be accessed at a medication administration time corresponding to the time instruction of the medications for exactly dispensing the medication in the respective medication compartment in timely organizing manner according to the prescription.

Once the pharmacist receives the medical record of the respective patient, the pharmacist will fill the medication dispenser with the prescription medication so as to accurately prepare the medications for the patient.

(D) Keep track a log of the medication dispenser at every time of each of the medication compartments being accessed for the medication to be delivered, so as to adjust an expenditure of prescription usage efficiently. Accordingly, the log of the medication dispenser is recorded in the medical database through the medical network.

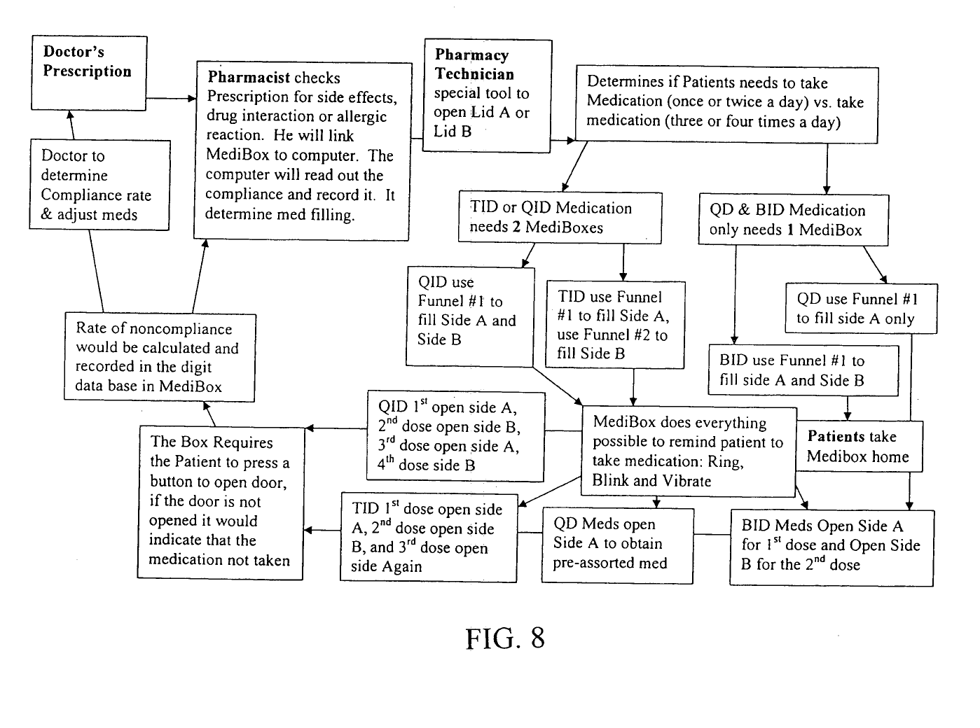

As shown in FIG. 8, two or more medication dispensers can be used for the patient depending on the frequency of the medication administration. For example, when the medications are needed to be taken by the patient three times a day (TID) or four times a day (QID), two medication dispensers may be needed. When the medications are needed to be taken by the patient once a day (QD) and two times a day, one medication dispenser is needed. Therefore, the pharmacy technician will determine how many medication dispenser of the present invention is used to guide the medication administration.

Therefore, the present invention can increase patient oral medical compliance, establish a patient-recipient database and decrease government expenditures on unused-unconsumed prescription medicines, so as to provide an efficient solution focusing on medication organization, delivery, reminder, compliance report, and secure patient database.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A medication dispenser, comprising:
a docking station comprising a medication container having a plurality of medication compartments for storing medications in a securely organized manner, and an accessing door which is coupled with said medication container and is adapted to align with one of said medication compartments for said corresponding medications withdrawing therefrom;
a time delivering controller which comprises a control panel supported by said docking station for presetting a predetermined time interval as a medication administration time corresponding to a time instruction of said medications, and a time reminder communicatively linked to said control panel for generating a delivery reminding signal at said medication administration time; and
a medication delivery controller comprising a power source which is electrically activated by said time delivering controller to actuate said docking station at a position that said accessing door is aligned with said corresponding medication compartment at said medication administration time, such that said accessing door is allowed to be opened for exactly dispensing said medication in said respective medication compartment in timely organizing manner.

2. The medication dispenser, as recited in claim 1, wherein said docking station further comprises a container enclosure that said accessing door is provided thereon, wherein said medication container comprises a disk body defining said medication compartments therein and securely enclosed by said container enclosure such that said docking station is normally sealed for preventing said medications from being withdrawn.

3. The medication dispenser, as recited in claim 1, wherein said time delivering controller further comprises a housing provided at said docking station and a time circuitry which is received in said housing and is electrically connected to said control panel, wherein said control panel is adapted for allowing an authorized person to preset said medication administration time to be stored in said time circuitry such that said time reminder is automatically triggered by said time circuitry to generate said delivery reminding signal at said medication administration time.

4. The medication dispenser, as recited in claim 2, wherein said time delivering controller further comprises a housing provided at said docking station and a time circuitry which is received in said housing and is electrically connected to said control panel, wherein said control panel is adapted for allowing an authorized person to preset said medication administration time to be stored in said time circuitry such that said time reminder is automatically triggered by said time circuitry to generate said delivery reminding signal at said medication administration time.

5. The medication dispenser, as recited in claim 3, wherein said time delivering controller further comprises a signal indicator electrically connected to said time reminder to indicate said delivery reminding signal.

6. The medication dispenser, as recited in claim 4, wherein said time delivering controller further comprises a signal indicator electrically connected to said time reminder to indicate said delivery reminding signal.

7. The medication dispenser, as recited in claim 4, wherein said power source comprises a power supply supported in said housing and an electric motor electrically connected to said power supply to drive said docking station at a position that said accessing door is aligned with said corresponding medication compartment at said medication administration time.

8. The medication dispenser, as recited in claim 6, wherein said power source comprises a power supply supported in said housing and an electric motor electrically connected to said power supply to drive said docking station at a position that said accessing door is aligned with said corresponding medication compartment at said medication administration time.

9. The medication dispenser, as recited in claim 1, further comprising means for releasably locking said accessing door with said medication container, wherein said accessing door is normally locked up with said medication container and is arranged to be unlocked at said medication administration time for delivering said medication in said respective medication compartment.

10. The medication dispenser, as recited in claim 4, further comprising means for releasably locking said accessing door with said medication container, wherein said accessing door is normally locked up with said medication container and is arranged to be unlocked at said medication administration time for delivering said medication in said respective medication compartment.

11. The medication dispenser, as recited in claim 8, further comprising means for releasably locking said accessing door with said medication container, wherein said accessing door is normally locked up with said medication container and is arranged to be unlocked at said medication administration time for delivering said medication in said respective medication compartment.

12. The medication dispenser, as recited in claim 1, further comprising a medical recorder communicatively linked to said time delivering controller for generating a medication log when said accessing door is accessed, wherein said medical recorder comprises a feedback memory electrically coupled with said time delivering controller and a signal generator arranged in such a manner that when said accessing door is opened for withdrawing said medication within said corresponding medication compartment, said signal generator generates a feedback signal as said medication log to be stored in said feedback memory so as to keep track a frequency of administration timely.

13. The medication dispenser, as recited in claim 4, further comprising a medical recorder communicatively linked to said time delivering controller for generating a medication log when said accessing door is accessed, wherein said medical recorder comprises a feedback memory electrically coupled with said time delivering controller and a signal generator arranged in such a manner that when said accessing door is opened for withdrawing said medication within said corresponding medication compartment, said signal generator generates a feedback signal as said medication log to be stored in said feedback memory so as to keep track a frequency of administration timely.

14. The medication dispenser, as recited in claim 11, further comprising a medical recorder communicatively linked to said time delivering controller for generating a medication log when said accessing door is accessed, wherein said medical recorder comprises a feedback memory electrically coupled with said time delivering controller and a signal generator arranged in such a manner that when said accessing door is opened for withdrawing said medication within said corresponding medication compartment, said signal generator generates a feedback signal as said medication log to be stored in said feedback memory so as to keep track a frequency of administration timely.

15. The medication dispenser, as recited in claim 4, wherein said docking station further comprises a plurality of sterilizing layers provided on said medication compartments respectively to keep said medication compartments sterile and clean for storing said medications.

16. The medication dispenser, as recited in claim 11, wherein said docking station further comprises a plurality of sterilizing layers provided on said medication compartments respectively to keep said medication compartments sterile and clean for storing said medications.

17. The medication dispenser, as recited in claim 14, wherein said docking station further comprises a plurality of sterilizing layers provided on said medication compartments respectively to keep said medication compartments sterile and clean for storing said medications.

18. The medication dispenser, as recited in claim 11, wherein said time delivering controller further comprises a LCD screen provided on said housing and electrically linked to said control panel for displaying medication info.

19. The medication dispenser, as recited in claim 14, wherein said time delivering controller further comprises a LCD screen provided on said housing and electrically linked to said control panel for displaying medication info.

20. The medication dispenser, as recited in claim 17, wherein said time delivering controller further comprises a LCD screen provided on said housing and electrically linked to said control panel for displaying medication info.

21. A method of timely dispensing medications by a medication dispenser, comprising the steps of:
(a) pre-storing the medications in a plurality of medication compartments of said medication dispenser in an organized manner, wherein said medications in said medication compartments are normally unable to be withdrawn;
(b) presetting a predetermined time interval as a medication administration time corresponding to a time instruction of said medications;
(c) generating a delivery reminding signal at said medication administration time; and
(d) allowing one of said medication compartments to be accessed at said medication administration time for exactly dispensing said medication in said respective medication compartment in timely organizing manner.

22. The method as recited in claim 21, before the step (a), further comprising a step of unlocking said medication dispenser in an authorized manner, wherein said medication dispenser is normally sealed for preventing said medication from being withdrawn such that said medication dispenser only allows to be opened by an authorized person to prepare said medications.

23. The method as recited in claim 21 wherein, in step (d), an accessing door of said medication dispenser is driven to turn at a position aligning with said respective medication compartment for allowing said medication therein to be withdrawn, wherein said accessing door is normally locked up and is adapted to be opened at said medication administration time for accessing said respective medication compartment.

24. The method as recited in claim 22 wherein, in step (d), an accessing door of said medication dispenser is driven to turn at a position aligning with said respective medication compartment for allowing said medication therein to be withdrawn, wherein said accessing door is normally locked up and is adapted to be opened at said medication administration time for accessing said respective medication compartment.

25. The method, as recited in claim 21, further comprising the steps of:
(e) detecting an access of said medication compartment to generate a medication log; and
(f) recording said medication log to keep track a frequency of administration timely.

26. The method, as recited in claim 22, further comprising the steps of:
(e) detecting an access of said medication compartment to generate a medication log; and
(f) recording said medication log to keep track a frequency of administration timely.

27. The method, as recited in claim 24, further comprising the steps of:
(e) detecting an access of said medication compartment to generate a medication log; and
(f) recording said medication log to keep track a frequency of administration timely.

28. A method of promoting compliance of medication by a medication dispenser, comprising the steps of:
(a) communicatively networking physicians to form a medical network;
(b) recording a prescription as a medical record when said prescription is transmitted through said medical network, wherein said prescription contains a list of said medications for a particular patient and a time instruction of said medications;
(c) preparing said medications in a plurality of medication compartments of said medication dispenser in an organized manner, wherein each of said medication compartments is allowed to be accessed at a medication administration time corresponding to said time instruction of said medications for exactly dispensing said medication in said respective medication compartment in timely organizing manner according to said prescription; and
(d) keep tracking a log of said medication dispenser at every time of each of said medication compartments being accessed for said medication to be delivered, so as to adjust an expenditure of prescription usage efficiently.

29. The method as recited in claim 28 wherein, in step (b), said medical records are saved and stored in a medical database that said physicians with authorization are allowed to access said medical database through said medical network.

30. The method as recited in claim 28 wherein, in step (c), said medications are prepared in said medication dispenser and said medication administration time is preset in said medication dispenser by said physicians.

31. The method as recited in claim 29 wherein, in step (c), said medications are prepared in said medication dispenser and said medication administration time is preset in said medication dispenser by said physicians.

32. The method as recited in claim 29 wherein, in step (d), said log of said medication dispenser is recorded in said medical database through said medical network.

33. The method as recited in claim 31 wherein, in step (d), said log of said medication dispenser is recorded in said medical database through said medical network.
